(19) United States
(12) Patent Application Publication
(10) Pub. No.: US 2024/0411580 A1
(43) Pub. Date: Dec. 12, 2024

(54) FAST PATH INTERRUPT INJECTION

(71) Applicant: Microsoft Technology Licensing, LLC, Redmond, WA (US)

(72) Inventors: Rian Patrick QUINN, Highlands Ranch, CO (US); Xin David ZHANG, Duvall, WA (US)

(21) Appl. No.: 18/345,082

(22) Filed: Jun. 30, 2023

Related U.S. Application Data
(60) Provisional application No. 63/507,282, filed on Jun. 9, 2023.

(51) Int. Cl. G06F 9/455

(52) U.S. Cl. CPC G06F 9/45558; G06F 2009/45579

(57) ABSTRACT

The state of an interrupt is identified. An eligibility value corresponding to the interrupt is generated based on the state of the interrupt. The eligibility value is indicative of whether the interrupt should be processed by a first processing path or a second processing path, the second processing path being lower latency than the first processing path, and the second processing path bypassing operations performed in the first processing path. When an interrupt is received at an assembly language processing system, from a hardware device, the assembly language processing system accesses the eligibility value corresponding to the interrupt and routes the interrupt to the first or second processing path based on the eligibility value.

### CROSS-REFERENCE TO RELATED APPLICATION

The present application is based on and claims the benefit of U.S. provisional patent application Ser. No. 63/507,282, filed Jun. 9, 2023, the content of which is hereby incorporated by reference in its entirety.

### BACKGROUND

Computing systems are currently in wide use. Such computing systems often run an operating system that operates based on interrupts.

Some interrupts are generated by hardware devices. Such an interrupt is a signal that is caused by some action taken by the hardware device. For example, keystroke depressions and mouse movements cause hardware interrupts. The signal is sent to a central processing unit. When an interrupt is received, a central processing unit stops what it is doing, saves the state information identifying the state of the task that it is performing, and then processes the interrupt. In order to process the interrupt, the CPU executes a piece of code corresponding to the interrupt and then returns to the original task it was performing by reloading the state information and continuing to execute the task.

Some current computing systems place an intermediate processing layer between the hardware devices that generate interrupts and the operating system. The intermediate processing layer includes security and management processes, which enhance the security of the operating system and protect the operating system from surreptitious attacks. The intermediate processing layer is often referred to as a hypervisor. The hypervisor incorporates security processing as well as management operations which manage the instantiation, allocation, and use of virtual processors, among other things. When the hypervisor is in place, then interactions between the operating system and hardware devices pass through the hypervisor.

The discussion above is merely provided for general background information and is not intended to be used as an aid in determining the scope of the claimed subject matter.

### SUMMARY

The state of an interrupt is identified. An eligibility value corresponding to the interrupt is generated based on the state of the interrupt. The eligibility value is indicative of whether the interrupt should be processed by a first processing path or a second processing path, the second processing path being lower latency than the first processing path, and the second processing path bypassing operations performed in the first processing path. When an interrupt is received at an assembly language processing system, from a hardware device, the assembly language processing system accesses the eligibility value corresponding to the interrupt and routes the interrupt to the first or second processing path based on the eligibility value.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIG. 2 is a block diagram showing one example of an interrupt allocation controller.

FIG. 3 is a block diagram showing one example of an assembly code processing system.

FIGS. 4A and 4B (collectively referred to herein as FIG. 4) show a flow diagram illustrating one example of the operation of a hypervisor/security system.

FIG. 5 is a block diagram showing one example of a computing environment that can be used in the architectures and systems shown in the previous figures.

### DETAILED DESCRIPTION

In some computing systems, hardware interrupts are directly injected into the operating system. However, this can make the operating system susceptible to surreptitious attacks.

Therefore, as discussed above, some computing systems have an intermediate processing layer (hereinafter referred to as a hypervisor/security system) that sits between hardware devices and an operating system. Any interactions between the operating system and the hardware devices pass through the hypervisor/security system. Therefore, the hypervisor/security system can perform security tasks that protect the operating system from various different types of surreptitious attacks.

For instance, when an interrupt is received, an assembly code representation of the interrupt is generated and passed to a translation system, which translates that representation of the interrupt into a higher-level language representation (such as a representation in C). The higher-level representation of the interrupt is then passed to an interrupt management processing system that performs a wide variety of different types of checks and management operations corresponding to the interrupt. The interrupt is also operated on by a hypervisor management processing system, which performs other hypervisor management operations, such as instantiating additional virtual processors and retargeting commands among the various virtual processors, among other things. Once processed by the hypervisor/security system, the interrupt is injected into an operating system, such as by being written into an injection register where the operating system can access the interrupt, process the interrupt, and generate a return signal when the interrupt processing is complete.

It can thus be seen that where an interrupt is directly injected into the operating system by a hardware device, there is no latency incurred by performing the security and other management processing that is performed by a hypervisor/security system. However, the operating system is much more susceptible to a surreptitious attack. Where the hypervisor/security system is disposed between the hardware devices and the operating system, a great deal of latency can be introduced when processing interrupts.

By way of example, in some current systems, whenever an interrupt is received at an assembly language processing system, the assembly language processing system routes the interrupt along a first processing path that includes a first set of processing components that perform a first set of operations with respect to that interrupt before injecting the interrupt into the operating system. The first set of processing operations can include a wide variety of different types of checks to determine that the interrupt can be safely injected into the processor core. After the first set of processing operations are performed, the interrupt is returned to the assembly language processing system for injection into the operating system. Injecting the interrupt involves writing the interrupt into an injection register where the interrupt can be accessed by the operating system.

The present description proceeds based on analysis in which it has been found that, a vast majority of the time, the full first set of processing operations need not be performed. Instead, in accordance with the present description, a second set of processing operations, which is only a subset of the first set of processing operations (and which is much lower latency), needs to be performed by the hypervisor/security system, and the interrupt can then be injected directly into the operating system, bypassing the first set of processing operations.

The present description thus describes a system in which the state of an interrupt is maintained in a data store, along with an eligibility indicator that indicates whether the interrupt needs the first set of processing operations before being injected into the operating system, or whether the interrupt can be injected after only a subset of processing operations. In one example, the eligibility indicator indicates whether the assembly language processing system is capable of performing the subset of processing and, if so, the assembly language processing system performs the subset of processing operations and directly injects the interrupt into the operating system, bypassing the first set of processing operations. Thus, the subset of processing operations can be performed without ever generating a higher-level language representation of the interrupt, and without performing any of the other hypervisor/security system processing on the interrupt. Because the assembly language processing system is capable of performing the subset of processing operations to be able to inject the interrupt, this greatly reduces the latency incurred in processing interrupts, while still maintaining the security provided by the hypervisor/security system.

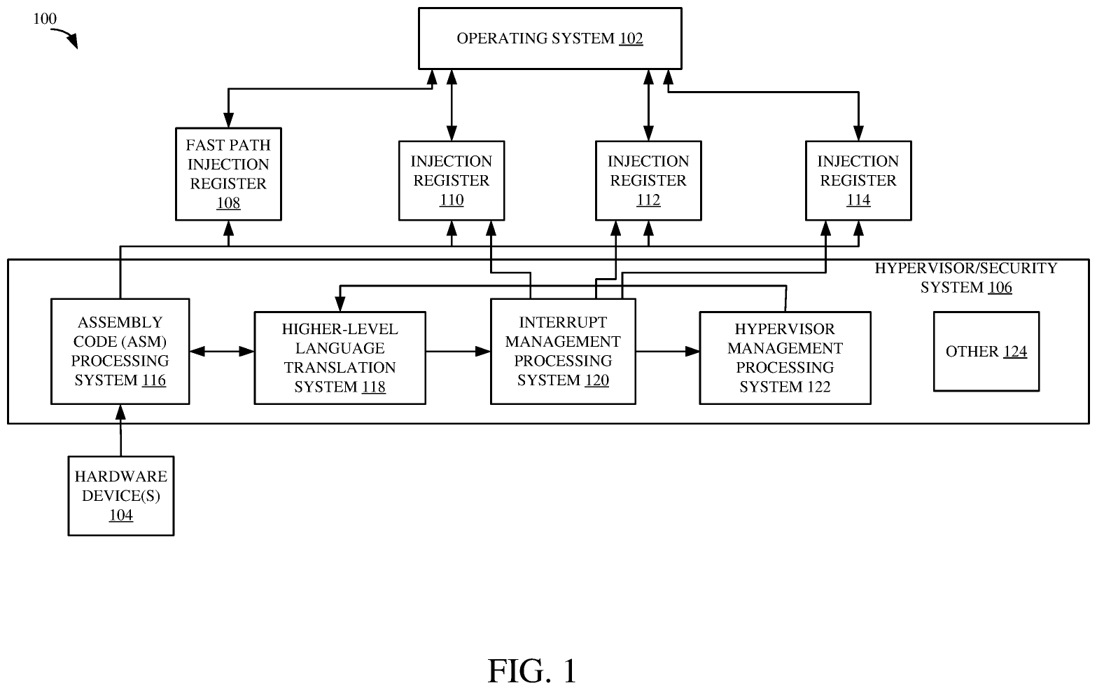

FIG. 1 is a block diagram showing one example of computing system architecture 100 in which an operating system 102 (which may be run on a virtual processor—or VP) receives interrupts from one or more hardware devices 104 through a hypervisor/security system 106. In order to inject an interrupt into the operating system 102, hypervisor/security system 106 writes the interrupt into one of a set of injection registers 108, 110, 112, and 114. In the example shown in FIG. 1, hypervisor/security system 106 includes an assembly code (ASM) processing system 116, a higher-level language translation system 118, an interrupt management processing system 120, a hypervisor management processing system 122, and other functionality 124.

Before describing the overall operation of computing system architecture 100 in more detail, a description of some of the items in computing system architecture 100, and their operation, will first be provided. In one example, interrupt management processing system 120 maintains an array of data structures where each data structure corresponds to an interrupt. The information in the data structure identifies the state of the interrupt, among other things. Based upon the state of the interrupt (and possibly other criteria), interrupt management processing system 120 generates a fast path eligibility indicator that indicates whether this particular interrupt is eligible for fast path processing, in which case only the subset of processing operations is performed resulting in a reduction in the latency incurred in processing the interrupt, or whether the interrupt should undergo slow path processing in which case the full set of processing operations is performed. The fast path eligibility indicator is stored in the data structure corresponding to that interrupt.

When an interrupt is received by ASM processing system 116 (such as from a hardware device 104), ASM processing system 116 indexes into an array of data structures maintained by interrupt management processing system 120 to query the fast path eligibility indicator corresponding to the received interrupt. If the eligibility indicator indicates that this interrupt is eligible for fast path processing, then ASM processing system 116 performs a subset of the processing that would otherwise be performed by hypervisor/security system 106 on the interrupt, and directly injects the interrupt into operating system 102 by writing into one of the injection registers 108-114. In one example, a specific one of the injection registers 108-114 is allocated for fast path processing so that only interrupts that are to be injected into operating system 102 using fast path processing are written into that injection register. For purposes of the present discussion, it will be assumed that the injection register allocated to fast path processing of interrupts is injection register 108. Thus, injection register 108 may be referred to herein as a fast path injection register 108.

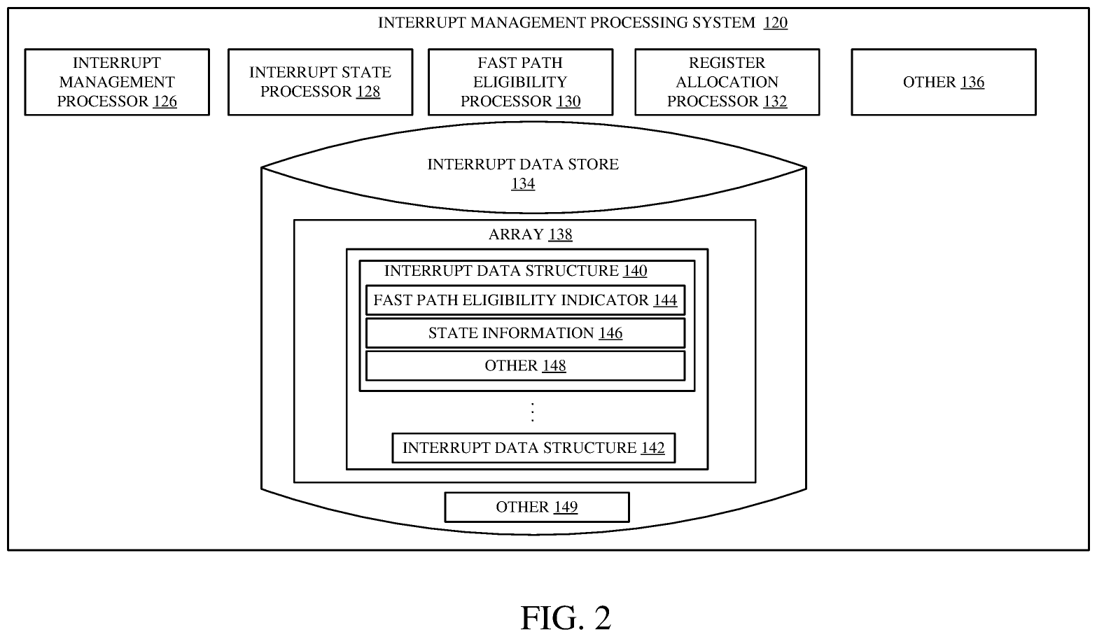

If ASM processing system 116 determines that the interrupt is not eligible for fast path processing (e.g., based upon the fast path eligibility indicator retrieved for this interrupt), then ASM processing system 116 routes the interrupt along a first processing path. For example, ASM processing system 116 passes the interrupt to higher-level language translation system 118, which generates a higher-level language representation of the interrupt (such as a representation in C) and passes the higher-level representation of the interrupt to interrupt management processing system 120. Interrupt management processing system 120 is described in greater detail below with respect to FIG. 2. Briefly, however, interrupt management processing system 120 can perform a wide variety of different types of processing operations in order to process the interrupt. For instance, interrupt management processing system 120 may deallocate injection registers 110, 112, and 114, determine the overall priority of all interrupts that are currently pending, and rewrite the interrupts into injection registers 110, 112, and 114 in priority order. Interrupt management processing system 120 can then update the state information in the array of data structures it is maintaining for each of the interrupts and then allocate an injection register 110-114 for the interrupt that is currently being processed.

Interrupt management processing system 120 can also invoke hypervisor management processing system 122. Hypervisor management processing system 122 can perform additional management operations with respect to the interrupt, such as to determine whether it is time to execute another VP or move a VP to another processing core, among a wide variety of other operations.

The result of the operations performed when the first processing path is taken (e.g., the results of processing by higher-level language translation system 118, interrupt management processing system 120, and hypervisor management processing system 122) are then returned to higher-level language translation system 118 which translates that result back into assembly code which can be processed by ASM processing system 116. ASM processing system 116 then writes the interrupt into the injection register 110-114 to which the interrupt was allocated to it by interrupt management processing system 120. Operating system 102 then accesses the interrupt in the injection register, executes the interrupt, and returns a value to that injection register indicating that the interrupt has been executed. It will be noted that, when ASM processing system 116 determines that the interrupt is eligible for fast path processing, ASM processing system 116 injects the interrupt directly into the operating system 102 by writing the interrupt to injection register 108, bypassing all the other processing performed by higher-level language translation system 118, interrupt management processing system 120, and hypervisor management processing system 122.

It can thus be seen that, by maintaining the fast path eligibility indicator for each interrupt in the data structures maintained by interrupt management processing system 120, many interrupts can be injected directly into operating system 102 by ASM processing system 116 without having to undergo any additional processing by higher-level language translation system 118, interrupt management processing system 120, and/or hypervisor management processing system 122. Instead, ASM processing system 116 only needs to execute a very limited quantity of code to query the eligibility indicator for the received interrupt and, then, assuming that the fast path eligibility indicator shows that the interrupt is eligible for fast path processing, ASM processing system 116 can directly inject that interrupt into operating system 102 by writing it into fast path injection register 108, thus reducing the processing overhead needed to process the interrupt and also reducing the latency incurred in processing the interrupt.

FIG. 2 is a block diagram showing one example of interrupt management processing system 120 in more detail. In the example shown in FIG. 2, interrupt management processing system 120 includes interrupt management processor 126, interrupt state processor 128, fast path eligibility processor 130, register allocation processor 132, and interrupt data store 134. Interrupt management processing system 120 can also include a wide variety of other functionality 136 as well. In the example shown in FIG. 2, interrupt data store 134 includes an array 138 of interrupt data structures 140-142 and other items 149. Each interrupt data structure 140-142 corresponds to a different interrupt. In the example shown in FIG. 2, the interrupt data structures 140-142 contain similar information. Therefore, only interrupt data structure 140 will be described in more detail.

In the example shown in FIG. 2, interrupt data structure 140 includes fast path eligibility indicator 144, state information 146, and other information 148. Interrupt state processor 128 identifies the state of each interrupt and updates state information 146 to identify the state of the corresponding interrupt. Based upon the state information, fast path eligibility processor 130 determines whether the interrupt corresponding to interrupt data structure 140 is eligible for fast path injection into operating system 102. Fast path eligibility processor 130 generates the fast path eligibility indicator 144 to indicate the eligibility of that interrupt for fast path processing. In one example, fast path eligibility indicator 144 is a Boolean value that indicates whether the corresponding interrupt is eligible for fast path processing. When processing a received interrupt, and when interrupt management processing system 120 is to allocate an injection register for the interrupt, register allocation processor 132 identifies an injection register 110-114 that will be allocated to the received interrupt.

Interrupt management processor 126 can perform a wide variety of different types of management operations corresponding to the interrupt or that may affect the processing of the interrupt. For example, interrupt management processor 126 can intermittently run code to clean out injection registers 110-114 where the interrupt has already been executed by operating system 102. In another example, interrupt management processor 126 may process multiple interrupts at the same time to determine their priority so that they can be injected into operating system 102 in priority order, or, if all injection registers 110-114 are in use, the interrupts can be enqueued in a queue for later injection. Interrupt management processor 126 can also perform retargeting which identifies the particular CPU core that the interrupt will be injected into.

Also, interrupt state processor 128 maintains the state information 146 to indicate whether the interrupt is in the middle of a retarget operation and/or whether the interrupt is in an active state, among other things.

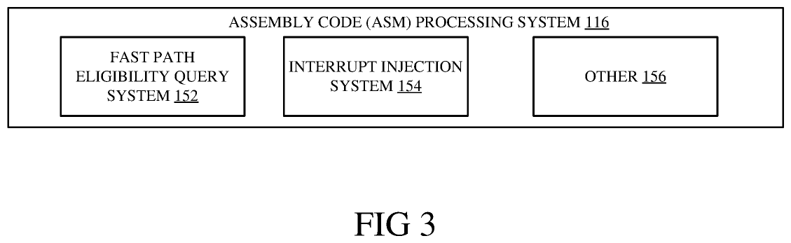

FIG. 3 is a block diagram showing one example of ASM processing system 116 in more detail. In the example shown in FIG. 3, ASM processing system 116 includes fast path eligibility query system 152, interrupt injection system 154, and a wide variety of other functionality 156.

When ASM processing system 116 receives an interrupt, fast path eligibility query system 152 uses the identity of that interrupt to index into the array 138 of interrupt data structures 140-142 to identify the location of the interrupt data structure for the corresponding interrupt (for purposes of the present discussion, it will be assumed that interrupt data structure 140 corresponds to the received interrupt). In one example, fast path eligibility query system 152 has access to a set of global variables that identify the location of array 138 in memory so that fast path eligibility query system 152 can quickly index into array 138 to find interrupt data structure 140 corresponding to the received interrupt. Fast path eligibility query system 152 then queries interrupt data structure 140 in interrupt data store 134 for the fast path eligibility indicator 144 in the identified interrupt data structure 140 to determine whether the interrupt is eligible for fast path processing.

Interrupt injection system 154 injects the interrupt into the operating system 102 by writing the interrupt into one of injection registers 108-114. Where the interrupt is eligible for fast path processing, interrupt injection system 154 directly injects the interrupt into operating system 102 by writing the interrupt into injection register 108, bypassing the processing operations performed by higher-level language translation system 118, interrupt management processing system 120, and hypervisor management processing system 122 in hypervisor/security system 106. When the interrupt is not eligible for fast path processing, then after the interrupt is fully processed by higher-level language translation system 118, interrupt management processing system 120, and hypervisor management processing system 122, interrupt injection system 154 injects the interrupt into the operating system 102 by writing it to the injection register 110-112 to which it was allocated.

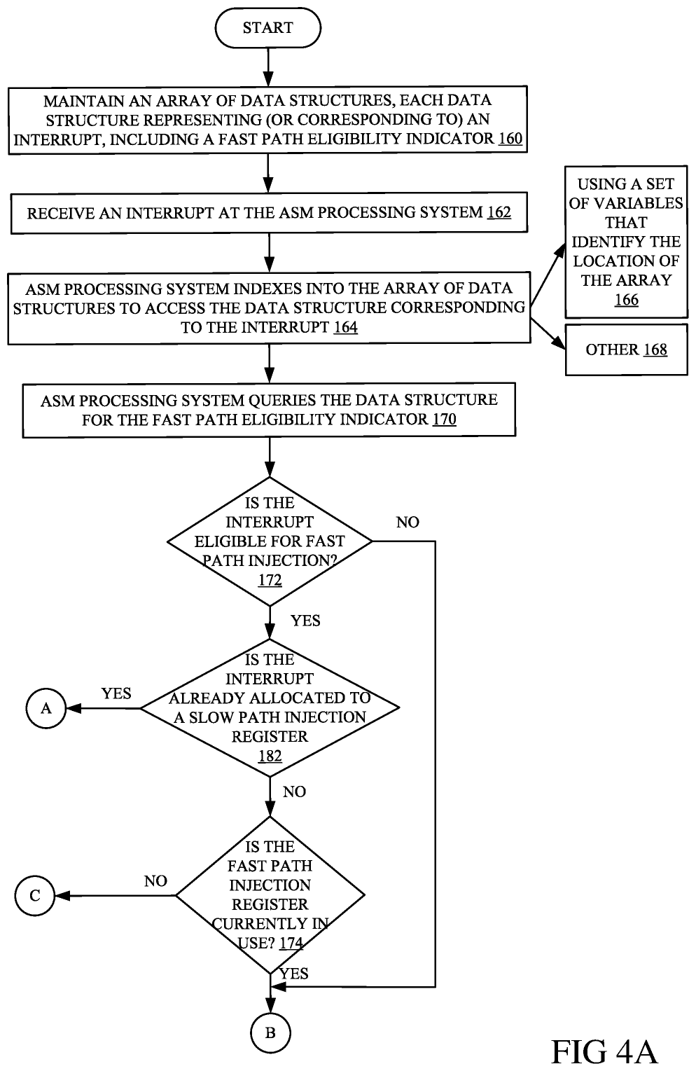

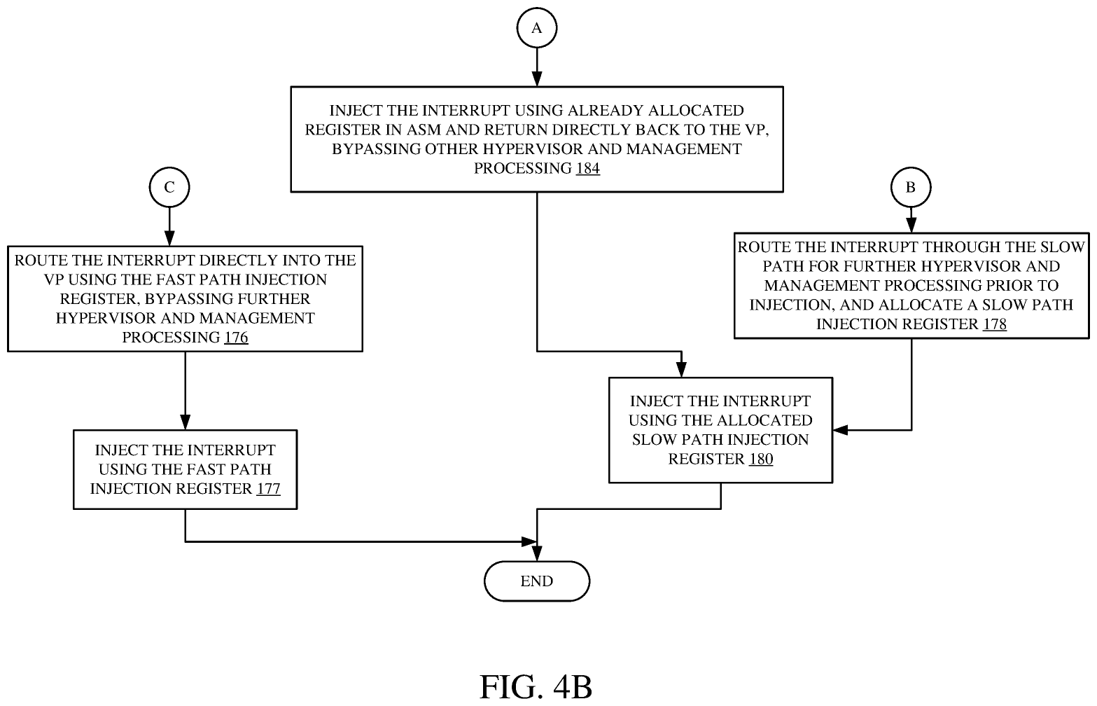

FIGS. 4A and 4B (collectively referred to herein as FIG. 4) show a flow diagram illustrating one example of the operation of computing system architecture 100 in handling interrupts. It is first assumed that interrupt management processing system 120 maintains the array 138 of interrupt data structures 140-142, each data structure stores interrupt information corresponding to an interrupt. Each interrupt data structure 140-142 also includes a fast path eligibility indicator 144. Maintaining the array 138 of interrupt data structures 140-142 is indicated by block 160 in the flow diagram of FIG. 4.

At some point, hypervisor/security system 106 receives an interrupt from a hardware device 104 and passes the interrupt to ASM processing system 116. Receiving an interrupt at ASM processing system 116 is indicated by block 162 in the flow diagram of FIG. 4. Fast path eligibility query system 152 in ASM processing system 116 then accesses array 138 of interrupt data structures 140-142 to access the data structure (in the present example, interrupt data structure 140) corresponding to the received interrupt, as indicated by block 164 in the flow diagram of FIG. 4. In one example, and as discussed above, fast path eligibility query system 152 uses a set of variables that identify the location of array 138 in memory so that fast path eligibility query system 152 can quickly access array 138. Accessing array 138 using a set of variables that identify the location of array 138 in memory is indicated by block 166 in the flow diagram of FIG. 4. Fast path eligibility query system 152 can access the data structure in other ways as well, as indicated by block 168.

Fast path eligibility query system 152 then queries the interrupt data structure 140 for the fast path eligibility indicator 144 corresponding to the interrupt being processed. Obtaining the fast path eligibility indicator 144 is indicated by block 170 in the flow diagram of FIG. 4. If, at block 172, fast path eligibility query system 152 determines that the interrupt is not eligible for fast path injection into operating system 102, then fast path eligibility query system 152 generates a signal indicative of this and interrupt injection system 154 routes the interrupt to the first (slow) processing path for further hypervisor and management processing by higher-level language translation system 118, interrupt management processing system 120, and hypervisor management processing system 122, prior to injection into operating system 102, as indicated by block 178 in the flow diagram of FIG. 4. ASM processing system 116 then, after the further processing performed by hypervisor/security system 106, injects the interrupt using the allocated injection register 110-114, as indicated by block 180 in the flow diagram of FIG. 4.

Returning to block 172, if the current interrupt is eligible for fast path processing, then fast path eligibility query system 152 determines whether the interrupt has already been allocated to one of the slow path injection registers 110-114. For example, it may be that the interrupt was fired previously and was allocated to injection register 110. At that point, operating system 102 may have executed the interrupt and returned a signal to injection register 110, indicating that the interrupt has been executed. However, it may be that interrupt management processing system 120 has not performed its intermittent processing where it cleans the executed interrupts out of the injection registers 110-114. Therefore, the current interrupt may be the same as the interrupt that was previously allocated to register 110, and the previous interrupt is still allocated to register 110 because it has not been cleaned out yet, even though that interrupt has already been executed by operating system 102.

This means that the interrupt will be eligible for fast path processing as determined at block 172, and also that the interrupt will already have been allocated to a slow path injection register (for purposes of the present example, injection register 110), as determined at block 182 in the flow diagram of FIG. 4. In such a scenario, fast path eligibility query system 152 in ASM processing system 116 will know that the interrupt can be directly injected into operating system 102 by writing it into injection register 110, bypassing further processing in hypervisor/security system 106, since the injection register 110 has already been allocated to that interrupt. Thus, interrupt injection system 154 injects the interrupt directly into operating system 102 using the injection register 110 to which it was already allocated, bypassing the additional hypervisor and management processing that would otherwise be performed by higher-level language translation system 118, interrupt management processing system 120, and hypervisor management processing system 122 in hypervisor/security system 106 and returns directly back to the VP. Injecting the interrupt directly into the operating system 102, bypassing the additional hypervisor processing, using the slow path injection register 110 to which the interrupt is already allocated is indicated by block 184 in the flow diagram of FIG. 4.

In this scenario, it can be seen that the interrupt will be processed using fast path processing without using fast path injection register 108. Instead, the fast path processing is performed using injection register 110, leaving injection register 108 available to perform other fast path injection of interrupts.

If the fast path eligibility indicator 144 indicates that the interrupt is eligible for fast path injection, as determined at block 172, and the interrupt is not already allocated to a slow injection register, as indicated by block 182, then fast path eligibility query system 152 determines whether the fast path injection register (in this case, injection register 108) is currently in use, as determined at block 174. If the interrupt is eligible for fast path injection, and if injection register 108 is not currently being used, then interrupt injection system 154 injects the interrupt directly into operating system 102 using the fast path injection register 108, bypassing further hypervisor and management processing that would otherwise be performed by the first processing path comprising higher-level language translation system 118, interrupt management processing system 120, and hypervisor management processing system 122 in hypervisor/security system 106. Routing the interrupt through the fast path is indicated by block 176, and injecting the interrupt directly into operating system 102 using the fast path injection register 108 and bypassing the further processing is indicated by block 177 in the flow diagram of FIG. 4.

It will be noted that, while the check to determine whether the interrupt is already allocated to a slow path injection register 110-114 is shown in FIG. 4 below block 172 and above block 174, that check could be performed elsewhere in the processing of the interrupt, even after, for example, determining whether injection register 108 is empty.

In another example, fast path eligibility query system 152, when determining whether an interrupt is eligible for fast path processing, may determine whether all of the slow path injection registers 110-114 are full. If that is the case, that means that interrupt management processing system 120 may have additional interrupts in a queue that are waiting to be written into the injection registers 110-114, in order of priority. Under those circumstances, ASM processing system 116 may not have access to the priority of the interrupts in the queue. Thus, in order to avoid injecting a lower priority interrupt using fast path injection register 108 prior to injecting higher priority interrupts which may be stored in a queue, fast path eligibility query system 152 simply determines that the interrupt is not eligible for fast path processing when all three of the slow path injection registers 110-114 are in use.

It has been found that in excess of 90% of all hardware interrupts received by hypervisor/security system 106 do not need to be processed by the first processing path comprising higher-level language translation system 118, interrupt management processing system 120, and hypervisor management processing system 122. In prior systems, those interrupts were fully processed, only to find out that they could be injected into the operating system 102. By contrast, the present system identifies such interrupts (e.g., those that do not need the full set of hypervisor processing to be injected into operating system 102) as interrupts that only need a subset of the processing, all of which can be performed by ASM processing system 116. That subset of processing can be done much more quickly so that, instead of routing the interrupt to the further processing that would be performed in the first processing path, ASM processing system 116 performs a subset of the processing and then directly injects the interrupt into operating system 102 using fast path injection register 108. Therefore, for more than 90% of all hardware interrupts that are received, the latency introduced by higher-level language translation system 118, interrupt management processing system 120, and hypervisor management processing system 122 can be completely avoided. This means that the interrupt can be processed in tens of CPU cycles, rather than hundreds of thousands of cycles. This greatly reduces latency associated with processing interrupts and greatly enhances the performance of the computing system.

It will be noted that the above discussion has described a variety of different systems, components, controllers, and/or logic. It will be appreciated that such systems, components, controllers, and/or logic can be comprised of hardware items (such as processors and associated memory, or other processing components, some of which are described below) that perform the functions associated with those systems, components, controllers, and/or logic. In addition, the systems, components, controllers, and/or logic can be comprised of software that is loaded into a memory and is subsequently executed by a processor or server, or other computing component, as described below. The systems, components, controllers, and/or logic can also be comprised of different combinations of hardware, software, firmware, etc., some examples of which are described below. These are only some examples of different structures that can be used to form the systems, components, controllers, and/or logic described above. Other structures can be used as well.

The present discussion has mentioned processors and servers. In one example, the processors and servers include computer processors with associated memory and timing circuitry, not separately shown. They are functional parts of the systems or devices to which they belong and are activated by and facilitate the functionality of the other components or items in those systems.

A number of data stores have also been discussed. It will be noted the data stores can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

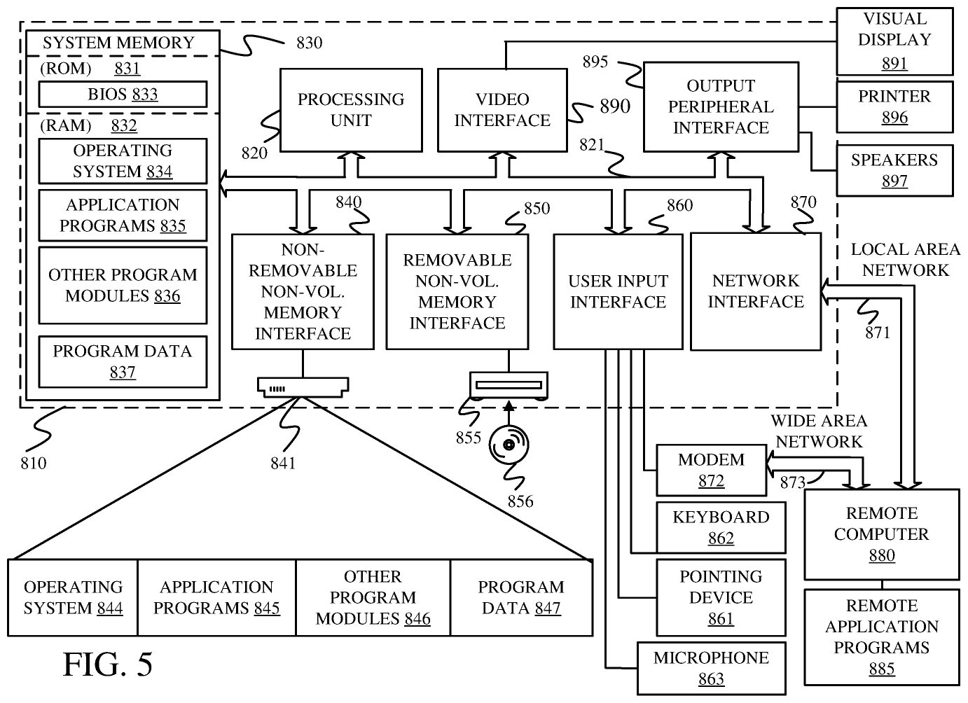

FIG. 5 is one example of a computing environment in which computing system architecture 100, or parts of it (for example), can be deployed. With reference to FIG. 5, an example system for implementing some embodiments includes a computing device in the form of a computer 810 programmed to operate as described above. Components of computer 810 may include a processing unit 820 (which can comprise processors or servers from previous FIGS.), a system memory 830, and a system bus 821 that couples various system components, including the system memory to the processing unit 820. The system bus 821 may be any of several types of bus structures including a memory bus or memory controller, a peripheral bus, and a local bus using any of a variety of bus architectures. By way of example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 5.

Computer 810 typically includes a variety of computer-readable media. Computer-readable media can be any available media that can be accessed by computer 810 and includes both volatile and nonvolatile media, removable and non-removable media. By way of example, computer-readable media may comprise computer storage media and communication media. Computer storage media is different from, and does not include, a modulated data signal or carrier wave. It includes hardware storage media, including both volatile and nonvolatile, removable and non-removable media implemented in any method or technology for storage of information such as computer-readable instructions, data structures, program modules, or other data. Computer storage media includes random access memory (RAM), read-only memory (ROM), electrically erasable programmable read-only memory (EEPROM), flash memory or other memory technology, compact disc-read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer-readable instructions, data structures, program modules, or other data in a transport mechanism and includes any information delivery media. The term “modulated data signal” means a signal that has one or more of its characteristics set or changed in such a manner as to encode information in the signal. By way of example, communication media includes wired media such as a wired network or direct-wired connection, and wireless media such as acoustic, radio frequency (RF), infrared, and other wireless media. Combinations of any of the above should also be included within the scope of computer-readable media.

The system memory 830 includes computer storage media in the form of volatile and/or nonvolatile memory such as ROM 831 and RAM 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, FIG. 5 illustrates operating system 834, application programs 835, other program modules 836, and program data 837.

The computer 810 may also include other removable/non-removable volatile/nonvolatile computer storage media. By way of example only, FIG. 5 illustrates a hard disk drive 841 that reads from or writes to non-removable, nonvolatile magnetic media and an optical disk drive 855 that reads from or writes to a removable, nonvolatile optical disk 856, such as a CD ROM or other optical media. Other removable or non-removable, volatile or nonvolatile computer storage media that can be used in the example operating environment include magnetic tape cassettes, flash memory cards, digital versatile disks, digital video tape, solid state RAM, solid state ROM, and the like. The hard disk drive 841 is typically connected to the system bus 821 through a non-removable memory interface, such as interface 840, and optical disk drive 855 is typically connected to the system bus 821 by a removable memory interface, such as interface 850.

Alternatively, or in addition, the functionality described herein can be performed, at least in part, by one or more hardware logic components. For example, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above, and illustrated in FIG. 5, provide storage of computer-readable instructions, data structures, program modules, and other data for computer 810. In FIG. 5, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball, or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port, or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device, or other common network node, and typically includes many or all of the elements described above relative to the computer 810. The logical connections depicted in FIG. 5 include a local area network (LAN) 871 and a wide area network (WAN) 873, but may also include other networks. Such networking environments are commonplace in offices, enterprise-wide computer networks, intranets, and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860 or other appropriate mechanism. In a networked environment, program modules depicted relative to the computer 810, or portions thereof, may be stored in the remote memory storage device. By way of example, FIG. 5 illustrates remote application programs 885 as residing on remote computer 880. It will be appreciated that the network connections shown are examples, and other means of establishing a communications link between the computers may be used.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computing system, comprising:
a processor; and
a computer-readable storage medium having stored thereon computer-executable instructions representing a hypervisor, the hypervisor having a first processing path representing a first set of processing operations and a second processing path representing a second set of processing operations, the second set of processing operations being smaller than the first set of processing operations, the computer-executable instructions being executable by the processor to cause the hypervisor to at least:
receive and process an interrupt from a hardware device prior to the interrupt reaching an operating system, processing the interrupt including:
at an interrupt management processing system of the hypervisor,
identifying state information corresponding to the interrupt,
generating a fast path eligibility indicator corresponding to the interrupt based on the state information, and
storing the state information and the fast path eligibility indicator in a data structure corresponding to the interrupt; and
at an assembly code processing system of the hypervisor,
receiving the interrupt from the hardware device,
accessing the fast path eligibility indicator from the data structure corresponding to the interrupt, and
routing the interrupt through the first processing path or the second processing path based on the fast path eligibility indicator corresponding to the interrupt.

2. The computing system of claim 1, wherein the assembly code processing system performs the second set of processing operations in the second processing path and to inject the interrupt into the operating system, bypassing the first processing path, based on the fast path eligibility indicator corresponding to the interrupt.

3. The computing system of claim 2, wherein the first processing path comprises: a language translation system that:
receives an assembly language representation of the interrupt from the assembly code processing system; and
performs one of the first set of processing operations by generating a higher-level language representation of the interrupt in a language that is a higher-level language than assembly language.

4. The computing system of claim 3, wherein the first processing path comprises: a management processing system that performs one of the first set of processing operations by performing a virtual processor management operation based on receiving the interrupt.

5. The computing system of claim 4, further comprising a plurality of injection registers, and wherein the assembly code processing system injects the interrupt into the operating system by writing interrupt information indicative of the interrupt into an allocated injection register that is allocated to the interrupt.

6. The computing system of claim 5, wherein the first processing path comprises the interrupt management processing system that performs one of the first set of processing operations by allocating the interrupt to one of the plurality of injection registers.

7. The computing system of claim 6, wherein the assembly code processing system:
determines that the interrupt is already allocated to an injection register; and
injects the interrupt directly into the operating system, bypassing the first processing path, by writing the interrupt into the injection register to which the interrupt is already allocated.

8. The computing system of claim 7, wherein,
one of the plurality of injection registers is allocated as a fast path injection register that is not allocated by the interrupt management processing system, and
all remaining injection registers of the plurality of injection registers comprise slow path injection registers that can be allocated by the interrupt management processing system.

9. The computing system of claim 8, wherein the assembly code processing system:
determines that all of the slow path injection registers are in use, and
routes the interrupt to the first processing path.

10. A computer-implemented method, comprising:
identifying state information corresponding to an interrupt;
generating a fast path eligibility indicator corresponding to the interrupt based on the state information;
storing the state information and the fast path eligibility indicator in a data structure corresponding to the interrupt;
receiving the interrupt, from a hardware device, at an assembly code processing system in a hypervisor system, the hypervisor system having a first processing path that performs a first set of processing operations and a second processing path that performs a second set of processing operations, the second set of processing operations being smaller than the first set of processing operations;
accessing, with the assembly code processing system, the fast path eligibility indicator from the data structure corresponding to the interrupt;
routing the interrupt, with the assembly code processing system, through the first processing path or the second processing path based on the fast path eligibility indicator corresponding to the interrupt; and
injecting the interrupt into an operating system.

11. The computer-implemented method of claim 10, wherein routing the interrupt comprises:
identifying the second processing path based on the fast path eligibility indicator corresponding to the interrupt; and
performing the second set of processing operations in the second processing path with the assembly code processing system, bypassing the first processing path, and wherein injecting the interrupt comprises injecting the interrupt into the operating system with the assembly code processing system.

12. The computer-implemented method of claim 10, wherein routing the interrupt comprises:
identifying the first processing path based on the fast path eligibility indicator corresponding to the interrupt; and
performing the first set of processing operations in the first processing path with the hypervisor system, and wherein injecting the interrupt comprises injecting the interrupt into the operating system with the assembly code processing system.

13. The computer-implemented method of claim 12, wherein performing the first set of processing operations comprises:
receiving an assembly language representation of the interrupt from the assembly code processing system; and
performing one or more of the first set of processing operations by generating a higher-level language representation of the interrupt in a language that is a higher-level language than assembly language.

14. The computer-implemented method of claim 13, wherein performing the first set of processing operations comprises:
performing one or more of the first set of processing operations by performing a virtual processor management operation based on receiving the interrupt.

15. The computer-implemented method of claim 14, wherein injecting the interrupt comprises:
writing, with the assembly code processing system, interrupt information indicative of the interrupt into an allocated injection register, of a plurality of injection registers, that is allocated to the interrupt.

16. The computer-implemented method of claim 15, wherein performing the first set of processing operations comprises:
allocating the interrupt to one of the plurality of injection registers.

17. The computer-implemented method of claim 16, wherein injecting the interrupt comprises:
determining that the interrupt is already allocated to an injection register; and
injecting the interrupt directly into the operating system, bypassing the first processing path, by writing the interrupt into the injection register to which the interrupt is already allocated.

18. The computer-implemented method of claim 17, wherein,
one of the plurality of injection registers is allocated as a fast path injection register that receives the interrupt after being routed through the second processing path, and
all remaining injection registers of the plurality of injection registers comprise slow path injection registers that receive the interrupt after being processed by the first processing path.

19. The computer-implemented method of claim 18, wherein routing the interrupt comprises:
determining that all the slow path injection registers are in use; and
routing the interrupt to the first processing path.

20. A computer system comprising:
a processor; and
a computer-readable storage medium having stored thereon computer-executable instructions representing a hypervisor that includes an interrupt state processor, a fast path eligibility processor, and an assembly code processing system, the computer-executable instructions being executable by the processor to at least:
at the hypervisor, receive an interrupt from a hardware device;
at the interrupt state processor, identify state information corresponding to the interrupt;
at the fast path eligibility processor, generate a fast path eligibility indicator corresponding to the interrupt based on the state information;
store the state information and the fast path eligibility indicator in a data structure corresponding to the interrupt; and
at the assembly code processing system, access the fast path eligibility indicator from the data structure corresponding to the interrupt, and either:
route the interrupt to a first set of processing components based on the fast path eligibility indicator, the first set of processing components performing a first set of processing operations on the interrupt prior to the interrupt being injected into an operating system, or
route the interrupt to a second set of processing components based on the fast path eligibility indicator, the second set of processing components performing a second set of processing operations on the interrupt prior to the interrupt being injected into the operating system, the second set of processing components being a subset of the first set of processing components.
